(19) United States
(12) Patent Application Publication
(10) Pub. No.: US 2015/0185746 A1
(43) Pub. Date: Jul. 2, 2015

(54) BANDGAP REFERENCE VOLTAGE GENERATING CIRCUIT

(71) Applicant: Silicon Motion Inc., Hsinchu County (TW)

(72) Inventor: Chiao-Hsing Wang, Taoyuan County (TW)

(21) Appl. No.: 14/324,054

(22) Filed: Jul. 3, 2014

(30) Foreign Application Priority Data
Dec. 27, 2013 (TW) 102148818

(51) Int. Cl. G05F 1/46

(52) U.S. Cl. CPC G05F 1/468

(57) ABSTRACT

A bandgap reference voltage generating circuit, comprising: a current mirror, for respectively generating a first, a second and a third currents at a first, a second and a third current output terminals; a first OP; an input voltage generating module, for respectively generating a first, a second voltages at a first, a second operational input terminals of the first OP according to the first, second currents, wherein the first OP generates a control voltage to the current mirror according to the first, second voltages; and a voltage keeping module, comprising a first current receiving terminal for receiving the third current to generate a third voltage, and a reference voltage generating terminal coupled to a reference voltage resistance device and for generating a reference voltage according to the third current. The voltage keeping module controls the third voltage to be the same as the first or the second voltage.

### BACKGROUND OF THE INVENTION

1. Field of the Invention

The present invention relates to a bandgap reference voltage generating circuit, and particularly relates to a bandgap reference voltage generating circuit which keeps the voltages at the current output terminals of the current mirror in the bandgap reference voltage generating circuit to be the same.

2. Description of the Prior Art

In the field of circuit design, a reference voltage generating circuit is always applied to generate an accurate reference voltage as a voltage standard for other devices. Voltage generating circuits can be classified to various kinds, and one of them is a bandgap reference voltage generating circuit. The devices inside such circuit adjusts the voltage or the current thereof responding to a temperature coefficient, such that the generated reference voltage can be kept at a stable value.

However, if the bandgap reference voltage generating circuit comprises one or more current mirrors, the voltage variation caused by the temperature variation for each current output terminal for the current mirror may be different. The currents for the current mirrors may be unstable due to such reasons, and the reference voltages are also accordingly unstable.

### SUMMARY OF THE INVENTION

One objective of the present invention is to provide a bandgap reference voltage generating circuit that can provide a stable reference voltage.

One embodiment of the present invention discloses a bandgap reference voltage generating circuit, which comprises: a current mirror, receiving a first predetermined voltage and generating a first current at a first current output terminal, generating a second current at a second current output terminal, and generating a third current at a third current output terminal, wherein the second current is mapped from the first current and the third current is mapped from the first current or the second current; a first operational amplifier (OP), comprising a first operation output terminal, a first operation input terminal and a second operation input terminal; an input voltage generating voltage, for generating a first voltage at the first operation output terminal according to the first current, and for generating a second voltage at the second operation input terminal according to the second current, wherein the first operational amplifier generates a control voltage at the first operational output terminal to the current mirror to control the first current according to the first voltage and the second voltage, to control the first current, the second current and the third current; a reference voltage resistance device; and a voltage keeping module, comprising a current receiving terminal and a reference voltage generating terminal, wherein the current receiving terminal receives the third current and generates a third voltage according to the third current, where the reference voltage generating terminal is coupled to the reference voltage resistance device and generates a reference voltage according to the third current, wherein the voltage keeping module receives the first voltage or the second voltage and controls the third voltage to be the same as the first voltage or the second voltage which is received.

In view of above-mentioned embodiments, the conventional issue that the voltage variation due to temperature changes maybe nonequivalent for each current output terminal can be improved, such that the bandgap reference voltage generating circuit can generate a more stable reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a bandgap reference voltage generating circuit according to one embodiment of the present invention.

FIG. 2 is a circuit diagram illustrating a detail circuit structure for a bandgap reference voltage generating circuit according to one embodiment of the present invention.

FIG. 3 is a schematic diagram illustrating comparison for the first current for the case that a voltage keeping module exists and for the third current for the case that a voltage keeping module does not exist.

FIG. 4 is a schematic diagram illustrating comparison for the voltages respectively for the case that a voltage keeping module exists and for the case that a voltage keeping module does not exist.

### DETAILED DESCRIPTION

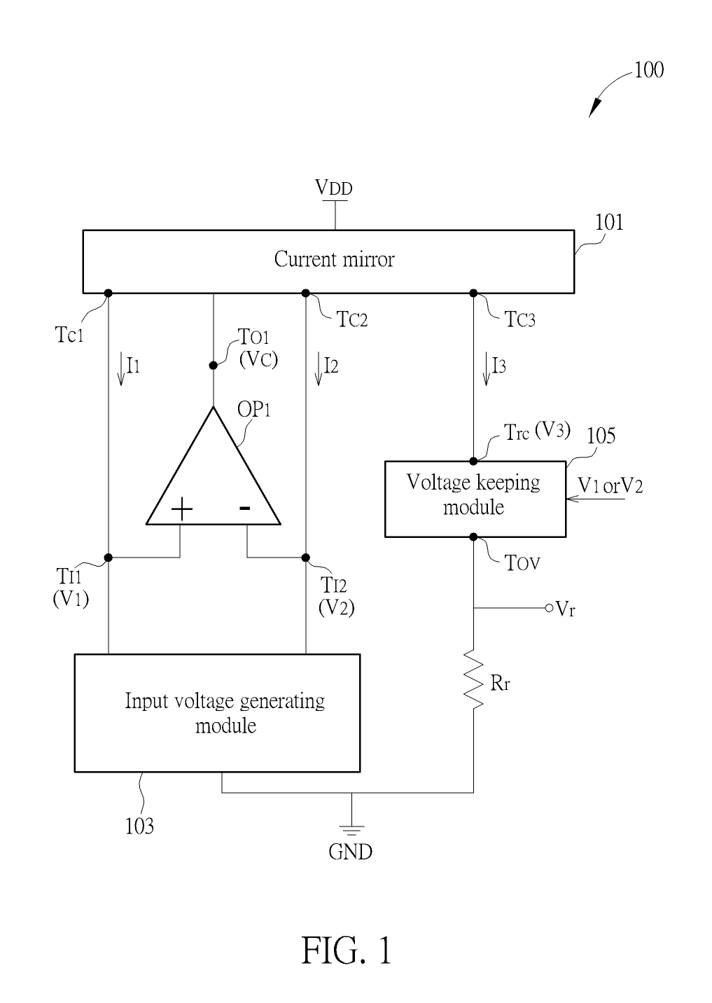

FIG. 1 is a block diagram illustrating a bandgap reference voltage generating circuit according to one embodiment of the present invention. As shown in FIG. 1, the bandgap reference voltage generating circuit 100 comprises a current mirror 101, a first operational amplifier OP₁, an input voltage generating voltage module 103, a voltage keeping module 105 and a reference voltage resistance device R_{T}. The current mirror 101 receives a first predetermined voltage VDD and generates a first current I₁ at a first current output terminal T_{c1}, generates a second current I₂ at a second current output terminal T_{c2}, and generates a third current I₃ at a third current output terminal T_{c3}. The second current I₂ is mapped from the first current I₁ and the third current I₃ is mapped from the first current I₁ or the second current I₂. The first operational amplifier OP₁ comprises a first operation output terminal Tₒ₁, a first operation input terminal T₁₁ and a second operation input terminal T₁₂. The input voltage generating voltage module 103 generates a first voltage V₁ at the first operation output terminal T₁₁ according to the first current I₁, and generates a second voltage V₂ at the second operation input terminal T₁₂ according to the second current I₂. The first operational amplifier OP₁ generates a control voltage V_{c} at the first operational output terminal Tₒ₁ to the current mirror 101 to control the first current I₁ according to the first voltage V₁ and the second voltage V₂, to control the first current I₁, the second current I₂ and the third current I₃. In the following embodiments, the first voltage V₁ and the second V₂ are the same due to the virtual short effect of the first operational amplifier OP₁, thus the first current I₁ and the second current I₂ are the same as well. Additionally, in the following embodiments the third current is mapped from the second current I₂ and is the same as the second current I₂, but not limited.

The voltage keeping module 105 comprises a current receiving terminal T_{rc} and a reference voltage generating terminal Tₒᵥ. The current receiving terminal T_{rc} receives the third current I₃ and generates a third voltage V₃ according to the third current I₃. The reference voltage generating terminal Tₒᵥ is coupled to the reference voltage resistance device Rᵣ and generates a reference voltage Vᵣ according to the third current I₃. The voltage keeping module 105 receives the first voltage V₁ or the second voltage V₂ and controls the third voltage V₃ to be the same as the first voltage V₁ or the second voltage V₂ which is received. By this way, the third current I₃ can be adjusted to be the same as the first current I₁ or the second current I₂. Accordingly, if the first current I₁ is set to be the second current I₂, the first current I₁, the second current I₂ and the third current I₃ are all simultaneous, thereby a stable reference voltage Vᵣ can be provided.

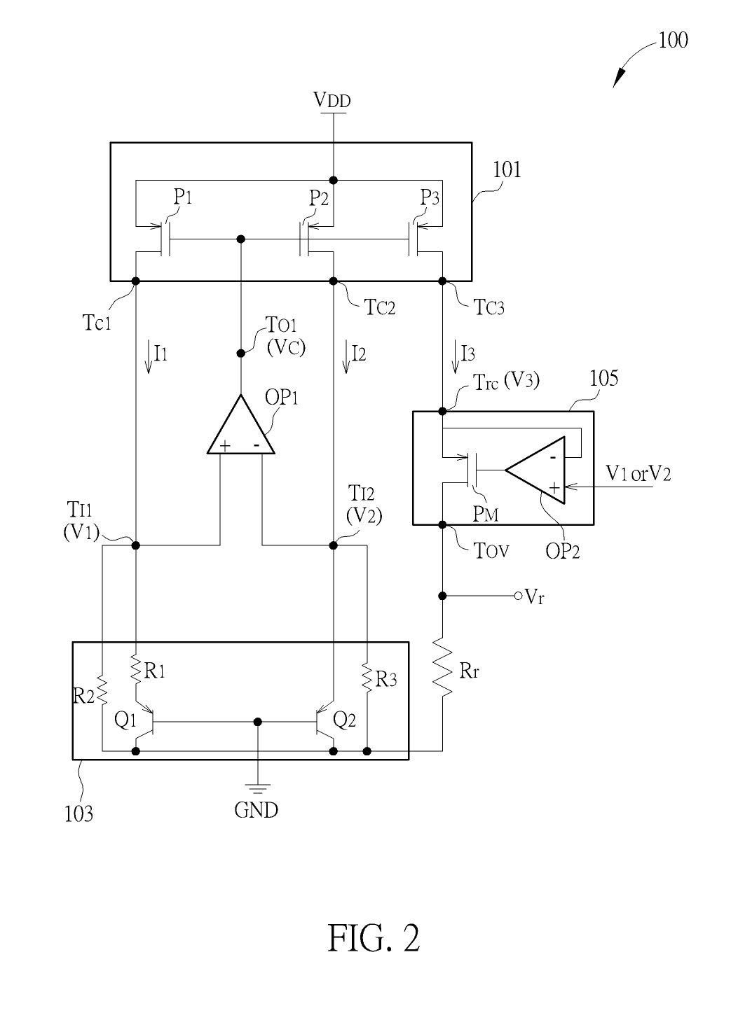

FIG. 2 is a circuit diagram illustrating a detail circuit structure for a bandgap reference voltage generating circuit according to one embodiment of the present invention. In the embodiment of FIG. 2, the voltage keeping module 105 comprises a PMOSFET P_{M} (metal oxide semiconductor field effect transistor) and a second operational amplifier OP₂. The PMOSFET P_{M} comprises a source terminal coupled to a current receiving terminal T_{rc} and a drain terminal coupled to a reference voltage generating terminal T_{rc}. The second operational amplifier OP₂ comprises: a third operational amplifier receiving one of the first voltage V₁ and the second voltage V₂, a fourth operational amplifier receiving the third voltage V3 (i.e. coupled to the current receiving terminal T_{rc}), and a second operational output terminal coupled to a gate terminal of the PMOSFET P_{M}. That is, the second operational amplifier OP₂ controls the conduction of the PMOSFET P_{M} according to the difference between the third voltage V₃ and one of the first voltage V₁/second voltage V₂, such that the third voltage V₃ can be the same as the first voltage V₁/the second voltage V₂. Please note the PMOSFET P_{M} can be replaced by other kinds of transistors.

In one embodiment, the current mirror 101 comprises a first PMOSFET P₁, a second PMOSFET P₂, and a third PMOSFET P₃. The first PMOSFET P₁ comprises a source terminal coupled to the first predetermined voltage V_{DD}, a drain terminal as the first current output terminal T_{c1} and a gate terminal receiving the control voltage V_{c}. The second PMOSFET P₂ comprises a source terminal coupled to the first predetermined voltage V_{DD}, a drain terminal as the second current output terminal T_{c2} and a gate terminal receiving the control voltage V_{c}. The third PMOSFET P₃ comprises a source terminal coupled to the first predetermined voltage V_{DD}, a drain terminal as the third current output terminal T_{c3} and a gate terminal coupled to a base of the second PMOSFET P₂.

In one embodiment, the input voltage generating module 103 comprises: a first resistance device R₁, a second resistance device R₂, a third resistance device R₃, a first BJT Q₁ and a second BJT Q₂. The first resistance device R₁ comprises a first terminal coupled to the first operational input terminal T1₁. The first BJT Q₁ comprises a collector coupled to a second terminal of the first resistance device R₁, and comprises an emitter coupled to a second predetermined voltage GND. The second resistance device R₂ comprising a first terminal coupled to the first operational input terminal T₁₁, and comprises a second terminal coupled to the second predetermined voltage GND. The second BJT Q₂ comprises a collector coupled to the second operational input terminal TI₂, comprises an emitter coupled to the second predetermined voltage GND, and comprises a basic coupled to a basic of the first BJT Q₁ and coupled to the second predetermined voltage GND. The third resistance device R₃ comprises a first terminal coupled to the second operational input terminal T₁₂, and comprises a second terminal coupled to the second predetermined voltage GND.

The detail operation for the embodiment shown in FIG. 2 will be described as follows. To avoid confusion, the situation that the voltage keeping module does not exist (i.e. the current receiving terminal T_{rc} and the reference generating terminal Tₒᵣ are the same terminal) will be explained first. The second resistor R₂ and the third resistor R₃ have the same resistance values, and a size of the first BJT Q₁ is x times for which of the first BJT Q₁. As above-mentioned description, the first voltage V₁ and the second voltage V₂ are the same due to the virtual short effect of the first operational amplifier OP₁. Accordingly, if the resistance values for the second resistor R₂ and the third resistor R₃ have the same resistance values, the currents flowing through the second resistor R₂ and the third resistor R₃ are the same, thereby the currents flowing through the first BJT Q₁ and the second BJT Q₂ are the same. In such case, the voltage difference between emitters for the first BJT Q₁ and the second BJT Q₂ is V_{T} ln X. V_{T} is a thermal voltage and equals to

$$\frac{KT}{q} ,$$

q means Coulomb charges, K is a Boltzmann's constant and T is a temperature. Therefore, the voltage difference for two terminals of the first resistor R₁ is V_{T} ln X.

Based on above-mentioned illustration, the first current I₁ is

$$\frac{{V}_{T} ln X}{{R}_{1}} + \frac{{V}_{EB 2}}{{R}_{2}} ,$$

V_{EB2} is a voltage difference between the basic and the emitter for the second BJT Q₂. The third current I₃ is also

$$\frac{{V}_{T} ln X}{{R}_{1}} + \frac{{V}_{EB 2}}{{R}_{2}}$$

since the first current I₁, the second current I₂, and the third current I₃ are the same, thus the reference voltage Vᵣ equals to

$$[ \frac{{V}_{T} ln X}{{R}_{1}} + \frac{{V}_{EB 2}}{{R}_{2}} ] {R}_{r} .$$

Ideally, V_{T} is directly proportional to temperature variation and the V_{EB2} is inversely proportional to temperature variation, thus variation for these two voltages will counteract each other. By this way, the reference voltage V, can be kept at a constant value ignoring temperature variation. However, if the voltage keeping module 105 does not exist, the first voltage V₁ and the second voltage V₂ changes but the reference voltage Vᵣ does not change if the temperature varies. In such case, the V_{DS} (i.e. voltages between the drain terminal and the source terminal) for the first PMOSFET P₁/the second PMOSFET P₂ and third PMOSFET P₃ are different, such that the first current, the second current, and the third current output from the current mirror are different, and the stability for the reference voltage Vᵣ is accordingly affected. If the voltage keeping module 105 is included, the voltage values for the first current output terminal T_{C1}, the second current output terminal T_{C2}, and the third current output terminal T_{C3} are kept the same (i.e. the first voltage V₁, the second voltage V₂ and the third voltage V₃ are the same). By this way, the V_{DS} for the first PMOSFET P₁/the second PMOSFET P₂ and third PMOSFET P₃ are the same, such that the stability for the reference voltage Vᵣ is raised. Also, a voltage difference exists between the third voltage V₃ and the reference voltage Vᵣ if the voltage keeping module 105 is included due to the devices of the voltage keeping module 105.

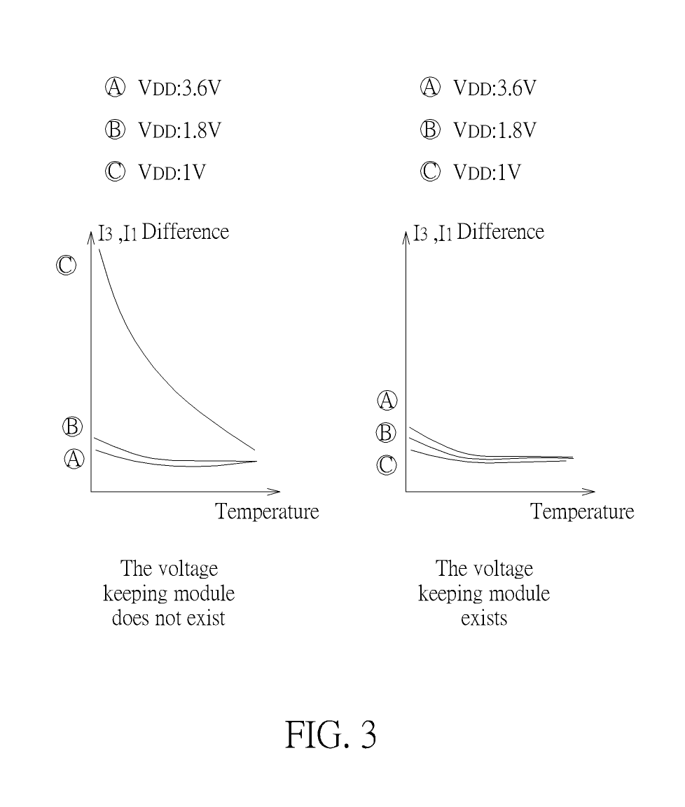

FIG. 3 is a schematic diagram illustrating comparison for the first current for the case that a voltage keeping module exists and for the third current for the case that a voltage keeping module does not exist. As shown in FIG. 3, if the voltage keeping module does not exist, the difference between the first current I₁ and the third current I₃ varies corresponding to the temperature. Such situation is more apparent if the first predetermined voltage V_{DD} is lower. The first current I₁ and the third current I₃ can be much the same if the voltage keeping module exists. The relation between the second current I₂ and the third current I₃ is the same as which of the first current I₂ and the third current I₃, thus it is omitted for brevity here.

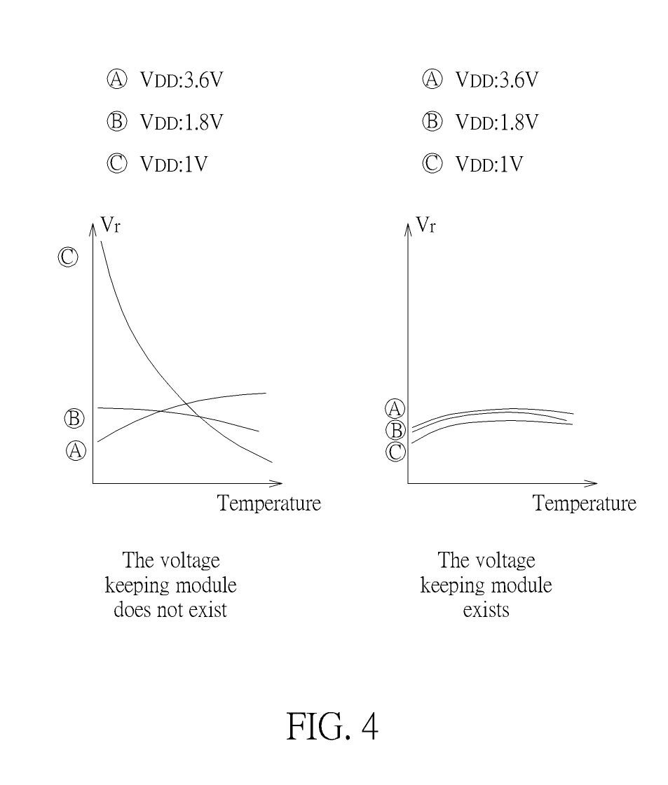

FIG. 4 is a schematic diagram illustrating comparison for the voltages respectively for the case that a voltage keeping module exists and for the case that a voltage keeping module does not exist. As shown in FIG. 4, if the voltage keeping module does not exist, the reference voltage varies corresponding to the temperature variation. Such situation is more apparent if the first predetermined voltage V_{DD} is lower. However, if the voltage keeping module does exists, the reference voltage is more stable.

In view of above-mentioned embodiments, the conventional issue that the voltage variation due to temperature changes maybe nonequivalent for each current output terminal can be improved, such that the bandgap reference voltage generating circuit can generate a more stable reference voltage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bandgap reference voltage generating circuit, comprising:
a current mirror, receiving a first predetermined voltage and generating a first current at a first current output terminal, generating a second current at a second current output terminal, and generating a third current at a third current output terminal, wherein the second current is mapped from the first current and the third current is mapped from the first current or the second current;
a first operational amplifier, comprising a first operation output terminal, a first operation input terminal and a second operation input terminal;
an input voltage generating voltage, for generating a first voltage at the first operation output terminal according to the first current, and for generating a second voltage at the second operation input terminal according to the second current, wherein the first operational amplifier generates a control voltage at the first operational output terminal to the current mirror to control the first current according to the first voltage and the second voltage, to control the first current, the second current and the third current;
a reference voltage resistance device; and
a voltage keeping module, comprising a current receiving terminal and a reference voltage generating terminal, wherein the current receiving terminal receives the third current and generates a third voltage according to the third current, where the reference voltage generating terminal is coupled to the reference voltage resistance device and generates a reference voltage according to the third current, wherein the voltage keeping module receives the first voltage or the second voltage and controls the third voltage to be the same as the first voltage or the second voltage which is received.

2. The bandgap reference voltage generating circuit of claim 1, wherein the first voltage and the second voltage are the same, the first current and the second current are the same.

3. The bandgap reference voltage generating circuit of claim 2, wherein the second current and the third current are the same.

4. The bandgap reference voltage generating circuit of claim 1, wherein the voltage keeping module comprises:
a transistor, having a terminal coupled to the current receiving terminal and having another terminal coupled to the reference voltage generating terminal; and
a second operational amplifier, comprising: a third operational amplifier receiving one of the first voltage and the second voltage, a fourth operational amplifier receiving the third voltage, and a second operational output terminal coupled to a control terminal of the transistor.

5. The bandgap reference voltage generating circuit of claim 4, wherein the transistor is a PMOSFET comprising a source terminal coupled to the current receiving terminal and a drain terminal coupled to the reference voltage generating terminal, where the second operational output terminal is coupled to a gate terminal of the PMOSFET.

6. The bandgap reference voltage generating circuit of claim 1, wherein the current mirror comprises:
a first PMOSFET, comprising a source terminal coupled to the first predetermined voltage, a drain terminal as the first current output terminal and a gate terminal receiving the control voltage;
a second PMOSFET, comprising a source terminal coupled to the first predetermined voltage, a drain terminal as the second current output terminal and a gate terminal receiving the control voltage; and
a third PMOSFET, comprising a source terminal coupled to the first predetermined voltage, a drain terminal as the third current output terminal and a gate terminal coupled to a base of the second PMOSFET.

7. The bandgap reference voltage generating circuit of claim 1, wherein the input voltage generating module comprises:
a first resistance device, comprising a first terminal coupled to the first operational input terminal;
a first BJT, comprising a collector coupled to a second terminal of the first resistance device, and comprising an emitter coupled to a second predetermined voltage;
a second resistance device, comprising a first terminal coupled to the first operational input terminal, and comprising a second terminal coupled to the second predetermined voltage;
a second BJT, comprising a collector coupled to the second operational input terminal, comprising an emitter coupled to the second predetermined voltage, and comprising a basic coupled to a basic of the first BJT and coupled to the second predetermined voltage; and
a third resistance device, comprising a first terminal coupled to the second operational input terminal, and comprising a second terminal coupled to the second predetermined voltage.
